(19) United States
(12) Patent Application Publication
(10) Pub. No.: US 2006/0216030 A1
(43) Pub. Date: Sep. 28, 2006

(54) Optical add-drop multiplexer

(75) Inventors: Byung-Jik Kim, Seongnam-si (KR); Sung-Bum Park, Suwon-si (KR); Seong-Taek Hwang, Pyeongtaek-si (KR)

Correspondence Address: CHA & REITER, LLC, 210 ROUTE 4 EAST STE 103, PARAMUS, NJ, 07652, US

(73) Assignee: Samsung Electronics Co.; LTD

(21) Appl. No.: 11/390,699

(22) Filed: Mar. 28, 2006

(30) Foreign Application Priority Data
Mar. 28, 2005 (KR) 2005-25449

(51) Int. Cl. H04J 14/02

(52) U.S. Cl. 398/84

(57) ABSTRACT

An optical add-drop multiplexer is disclosed. The optical add-drop multiplexer includes a first loop for dropping a first polarized light signal having a corresponding wavelength from a multiplexed downstream optical signal and adding a second polarized light signal having a corresponding wavelength to a multiplexed upstream optical signal and a second loop for adding a first polarized light signal having a corresponding wavelength to the downstream optical signal input from the first loop. An upstream optical signal is output in which a second polarized light signal having a corresponding wavelength is dropped from towards the first loop and the multiplezer also includes a Bragg grating placed between the first and second loops for reflecting the first and second polarized light signals having the corresponding wavelengths respectively towards the first and second loops.

### CLAIM OF PRIORITY

This application claims priority to an application entitled “Optical Add-Drop Multiplexer,” filed in the Korean Intellectual Property Office on Mar. 28, 2005 and assigned Serial No. 2005-25449, the contents of which are hereby incorporated by reference.

### BACKGROUND OF THE INVENTION

1. Field of the Invention

The present invention relates to an optical subscriber network, and more particularly to a loop-type, optical, add-drop multiplexer for an optical subscriber network.

2. Description of the Related Art

A passive optical subscriber network can provide various types of multimedia services through the Internet. Such passive optical subscriber networks include a central office for providing communication services, a plurality of service subscribers, and remote nodes for relaying the services between the central office and the subscribers.

However, it is difficult for a single central office to supply communication services to all subscribers in a large urban region that may include several hundred thousand subscribers.

In order to connect many subscribers to a central office, a metro access network has been proposed that includes a central office, a plurality of remote nodes connected to the central office and a plurality of subscribers connected to the remote nodes.

In the metro access network, the central office and the remote nodes are connected with one another in a ring shape.

Usually, the metro access network may employ a Wavelength Division Multiplexing (WDM) scheme that assigns a specific wavelength to an optical signal for optical communication.

Each of the remote nodes drops an optical signal having a specific wavelength assigned to the optical signal by the central office from a WDM optical signal transmitted from the central office, and adds an optical signal having a specific wavelength to a WDM optical signal and then transmits the WDM optical signal to the central office.

Each of the remote nodes includes an optical add-drop multiplexer that can drop and add an optical signal having the specific wavelength from/to the WDM optical signal.

FIG. 1 illustrates a conventional optical add-drop multiplexer 100. The conventional optical add-drop multiplexer 100 includes first, second, third, fourth, fifth and sixth circulators 110, 120, 130, 140, 150 and 160 establishing a circular loop, and first and second Bragg gratings placed in the circular loop. The first Bragg grating 170 is placed between the second and third circulators 120 and 130, while the second Bragg grating 180 is disposed between the fifth an sixth circulators 150 and 160.

The first circulator 110 inputs a multiplexed downstream optical signal 101 to the optical add-drop multiplexer 100 and outputs a multiplexed upstream optical signal 102 out of the optical add-drop multiplexer 100.

The second circulator 120 outputs the multiplexed downstream optical signal 101 through the first Bragg grating 170 towards the third circulator 130 while dropping a first light signal λei having a corresponding wavelength that is reflected by means of the first Bragg grating. The third circulator 130 adds the first light signal λei having the corresponding wavelength to the downstream optical signal input from the first Bragg grating 170 to output the downstream optical signal having the first light signal towards the fourth circulator 140.

The fourth circulator 140 outputs the downstream optical signal (λei) 101 outside the optical add-drop multiplexer 100 and outputs the multiplexed upstream optical signal λo towards the fifth circulator 150. The fifth circulator 150 outputs the upstream optical signal through the second Bragg grating 180 towards the sixth circulator 160. The second Bragg grating 180 reflects a second light signal λoi having a corresponding wavelength to be dropped towards the fifth circulator 150 which in turn drops the second light signal. The sixth circulator 160 adds the second light signal )oi having the corresponding wavelength to the upstream optical signal and outputs the upstream optical signal having the second light signal towards the first circulator 110.

The first Bragg grating 170 reflects the first light signal having the specific wavelength towards each of the second and third circulators 120 and 130, while the second Bragg grating 180 reflects the second light signal having the specific wavelength towards each of the fifth and sixth circulators 150 and 160.

However, such conventional optical add-drop multiplexers require a total of six elements for adding and dropping the optical signal having a single specific wavelength. This includes three elements for adding the optical signal and three elements for dropping the optical signal. This arrangement is costly from a manufacturing or construction perspective.

### SUMMARY OF THE INVENTION

One aspect of the present invention relates to an optical add-drop multiplexer that can reduce the construction cost of a wavelength division multiplexing (WDM) optical network.

One embodiment of the present invention is directed to an optical add-drop multiplexer including a first loop for dropping a first polarized light signal having a corresponding wavelength from a multiplexed downstream optical signal and adding a second polarized light signal having a corresponding wavelength to a multiplexed upstream optical signal and a second loop for adding the first polarized light signal having the corresponding wavelength to the downstream optical signal input from the first loop and outputting an upstream optical signal. A second polarized light signal having a corresponding wavelength is dropped from, towards the first loop. The multiplexer also includes a Bragg grating placed between the first and second loops for reflecting the first and second polarized light signals having the corresponding wavelength respectively towards the first and second loops.

### BRIEF DESCRIPTION OF THE DRAWINGS

The above and other aspects, features and embodiments of the present invention will be more apparent from the following detailed description taken in conjunction with the accompanying drawings, in which:

FIG. 1 illustrates the construction of the conventional optical add-drop multiplexer;

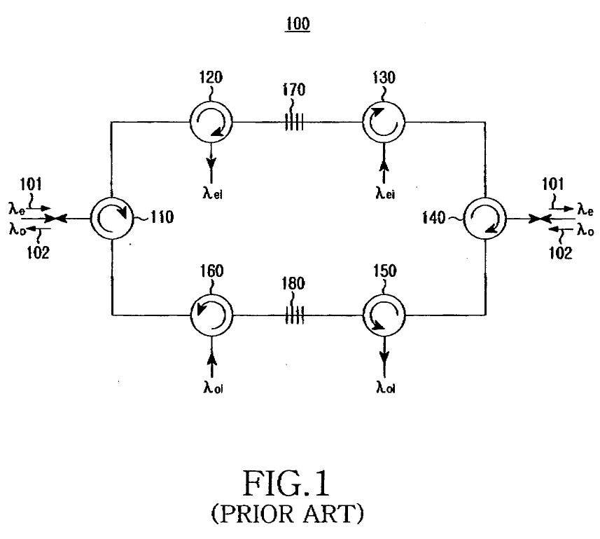

FIG. 2 illustrates a construction of an optical add-drop multiplexer according to a first embodiment of the present invention; and

FIG. 3 illustrates a construction of an optical add-drop multiplexer according to a second embodiment of the present invention.

### DETAILED DESCRIPTION

Hereinafter, embodiments of the present invention will be described with reference to the accompanying drawings. In the following description of the present invention, a detailed description of known functions and configurations incorporated herein will be omitted to avoid obscuring the subject matter.

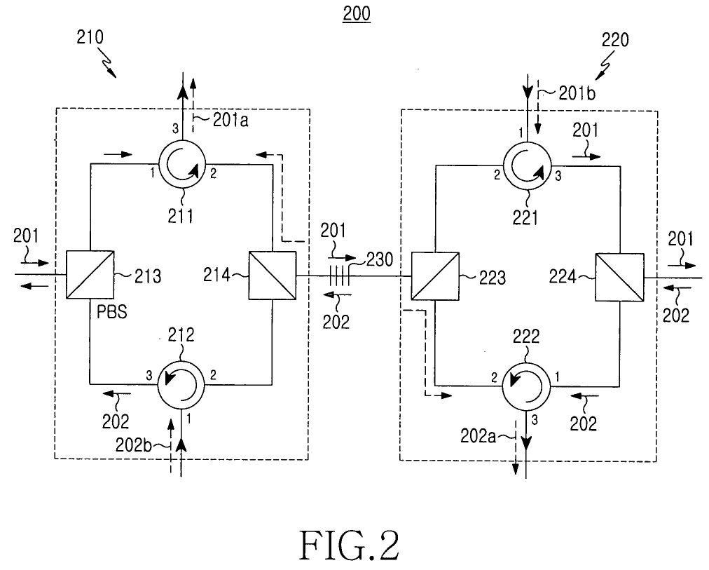

FIG. 2 illustrates a construction of an optical add-drop multiplexer 200 according to a first embodiment of the present invention. The optical add-drop multiplexer 200 includes ring-shaped first and second loops 210 and 220 and a Bragg grating 230 disposed between the first and second loops 210 and 220 for connecting the first loop 210 with the second loop 220.

The optical add-drop multiplexer 200 can be used, for example, as a node of a WDM optical communication network. The optical add-drop multiplexer 200 adds or drops first and second polarized light signals 201a, 201b, 202a and 202b having corresponding wavelengths to/from a downstream optical signal 201 in which the first polarized light signals having different wavelengths are multiplexed and an upstream optical signal 202 in which the second polarized light signals having different wavelengths are multiplexed. The first and second polarized light signals 201a, 201b, 202a and 202b have a polarization mode in which the first and second polarized light signals are orthogonal to each other. For example, the first polarized light signals are in a transverse electric polarized mode, while the second polarized light signals are in a transverse magnetic polarized mode.

The first loop 210 includes first and second circulators 211 and 212, and first and second polarized light signal branching filters 213 and 214. The first loop 210 drops the first polarized light signal 201a having a corresponding wavelength from the multiplexed downstream optical signal 201 and adds the second polarized light signal 202b having a corresponding wavelength to the multiplexed upstream optical signal 202.

Each of the first and second circulators 211 and 212 includes first, second and third ports. The first port of the first circulator 211 is connected to the second polarized light signal branching filter 213, and the second port of the first circulator 211 connected to the first polarized light signal branching filter 214. The second port of the second circulator 212 is connected to the first-polarized light signal branching filter 214, and the third port of the second circulator 212 connected to the second polarized light signal branching filter 213.

The first circulator 211 outputs a downstream optical signal 201, which is input through the first port thereof via the second polarized light signal branching filter 213 to the first circulator 211, through the second port thereof towards the first polarized light signal branching filter 214 while outputting through the third port thereof the first polarized light signal 201a reflected by the Bragg grating 230.

The second circulator 212 outputs the second polarized light signal 202b, which has a corresponding wavelength and is input through the first port thereof, through the second port thereof towards the first polarized light signal branching filter 214. The second circulator 212 adds the second polarized light signal 202b reflected by the Bragg grating 230 to the upstream optical signal 202 input through the first polarized light signal branching filter 214. The upstream optical signal 202 having the second polarized light signal 202b is then output through the third port thereof towards the second polarized light signal branching filter 213.

The first and second polarized light signal branching filters 214 and 213 include a polarization signal splitter, which can add or drop the first and second polarized light signals 201a and 202b in polarization modes orthogonal to each other. The first and second polarized light signals 201a and 202b are then output through respective routes.

The first polarized light signal branching filter 214 is placed between the second port of the first circulator 211 and the second port of the second circulator 212 to output either the downstream optical signal 201 through the Bragg grating 230 towards the second loop 220 or the upstream optical signal 202 input from the Bragg grating 230 towards the second circulator 212. Otherwise, the first polarized light signal branching filter 214 outputs the first polarized light signal 201a, which has a corresponding wavelength and is reflected by the Bragg grating 230, towards the first circulator 211 while outputting the second polarized light signal 202b, which has a corresponding wavelength and is reflected by the Bragg grating 230, towards the second circulator 212.

The second polarized light signal branching filter 213 is disposed between the first port of the first circulator 211 and the third port of the second circulator 212, which inputs the multiplexed downstream optical signal 201 in the first loop 210 and outputs the upstream optical signal 202 outside the optical add-drop multiplexer 200. The second polarized light signal branching filter 213 outputs the multiplexed downstream optical signal 201 towards the first circulator 211 and outputs the upstream optical signal 202 output from the second circulator 212 out of the optical add-drop multiplexer 200.

The second loop 220 includes third and fourth circulators 222 and 221 and third and fourth polarized light signal branching filters 223 and 224. The second loop 220 adds the first polarized light signal 201b having a corresponding wavelength to the downstream optical signal 201 input from the first loop 210 and outputs the upstream optical signal 202, which the second polarized light signal 202a having a corresponding wavelength is dropped from, towards the first loop 210.

The third and fourth circulators 222 and 221 are provided with first, second and third ports, respectively, which are connected with each other to form a ring shape. The second loop 220 has the ring shape in which the second port of the third circulator 222 is connected with the second port of the fourth circulator 221 and the first port of the third circulator 222 connected with the third port of the fourth circulator 221. In the second loop 220, the third polarized light signal branching filter 223 is placed between the second port of the third circulator 222 and the second port of the fourth circulator 221 while the fourth polarized light signal branching filter 224 is disposed between the first port of the third circulator 222 and the third port of the fourth circulator 221.

The third circulator 222 outputs an upstream optical signal 202 input through the first port thereof towards the second port thereof, while dropping the second polarized light signal 202a reflected by the Bragg grating 230 through the third port thereof. The fourth circulator 221 outputs the first polarized light signal 201b, which has a corresponding wavelength and is input through the first port thereof, through the second port thereof and adds the first polarized light signal 201b reflected by the Bragg grating 230 to the downstream optical signal input through the second port thereof to output the downstream optical signal having the first polarized light signal through the third port thereof.

The fourth circulator 221 receives the first polarized light signal 201b having the corresponding wavelength to be transferred to the optical add-drop multiplexer 220 through the first port thereof from the outside of the multiplexer 220. The third circulator 222 drops the second polarized light signal 202a, which has a corresponding wavelength and is reflected by the Bragg grating 230 to be input through the second port thereof via the third polarized light signal branching filter 223, through the third port thereof.

The third polarized light signal branching filter 223 has one end connected to the Bragg grating 230 for outputting the downstream optical signal 201 input through the Bragg grating 230 towards the fourth circulator 221 and outputting the upstream optical signal 202 input from the third circulator 222 through the Bragg grating 230 towards the first loop 210. The third polarized light signal branching filter 223 outputs the first polarized light signal 201b reflected by the Bragg grating 230 towards the fourth circulator 221, while outputting the second polarized light signal 202a reflected by the Bragg grating 230 towards the third circulator 222.

The fourth polarized light signal branching filter 224 outputs the upstream optical signal 202 input from the outside toward the third circulator 222, while outputting the downstream optical signal 201 input from the fourth circulator 221 outside the optical add-drop multiplexer 200. The polarization signal splitter can be used as the third and fourth polarized light signal branching filters 222 and 221.

The Bragg grating 230 is disposed between the first and second loops 210 and 220 and reflects the first and second polarized light signals 201a, 201b, 202a and 202b having a corresponding wavelength respectively towards the first and second loops 210 and 220. The Bragg grating 230 branches the first polarized light signal 201a having a corresponding wavelength from the multiplexed downstream optical signal 201 input from the first loop 210, which in turn reflects the first polarized light signal 201a towards the first loop 210 and outputs the downstream optical signal 201 including the first polarized light signal having the rest of wavelengths. The Bragg grating 230 reflects the second polarized light signal 202b, which has a corresponding wavelength and is input from the first loop 210, towards the first loop 210.

The Bragg grating 230 branches the second polarized light signal 202a having a corresponding wavelength from the upstream optical signal 202 input from the second loop 220, which in turn reflects the second polarized light signal 202a towards the second loop 220. The upstream optical signal 202 including the second polarized light signal 202a having the rest of wavelengths is then output towards the first loop 210. The Bragg grating 230 reflects the first polarized light signal 201b, which has a corresponding wavelength and is input from the second loop 220 towards the second loop 220.

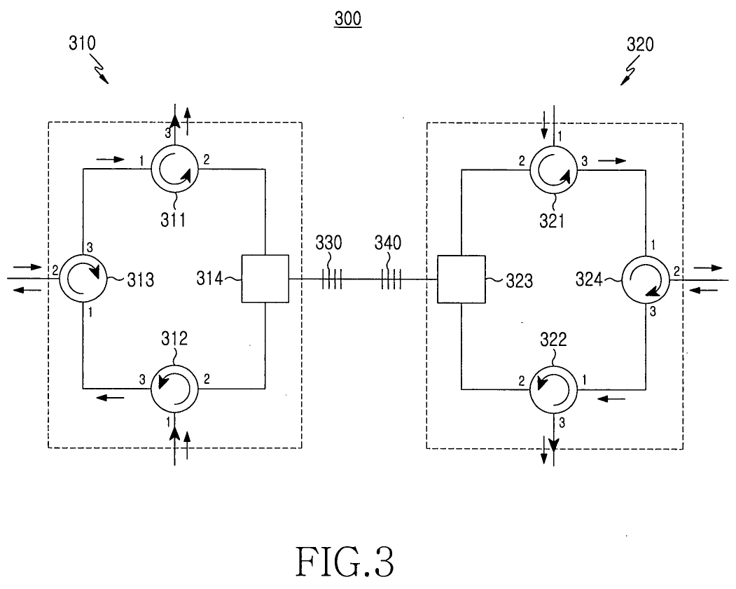

FIG. 3 illustrates a construction of the optical add-drop multiplexer 300 according to the second embodiment of the present invention. The optical add-drop multiplexer 300 includes a first loop 310 for dropping a first light signal having a corresponding wavelength from a multiplexed downstream optical signal and adding a second light signal having a corresponding wavelength to a multiplexed upstream optical signal and a second loop 320 for adding a first light signal having a corresponding wavelength to the downstream optical signal input from the first loop 310 and outputting the upstream optical signal. The second light signal having a corresponding wavelength is dropped from, towards the first loop 310. The optical add-drop multiplexer 300 also includes first and second Bragg gratings 330 and 340 placed between the first and second loops 310 and 320 for reflecting the first and second light signals having a corresponding wavelength respectively towards the first and second loops 310 and 320.

The first loop 310 has a ring shape, which includes first, second and third circulators 311, 313 and 312 for dropping the first light signal having a corresponding wavelength from the multiplexed downstream optical signal input therein and adding the second light signal having a corresponding wavelength to the upstream optical signal, to output the upstream and downstream optical signals out of the optical add-drop multiplexer 300, and a first interleaver 314 placed between the first and third circulators 311 and 312 to be connected with the Bragg grating 330.

The second circulator 313 inputs the multiplexed downstream optical signal from the outside into the first loop 310 and outputs the upstream optical signal out of the optical add-drop multiplexer 300.

The first circulator 311 outputs the downstream optical signal, which is input from the second circulator 313, through the first interleaver 314 towards the first Bragg grating 330 and drops the first light signal having a corresponding wavelength and reflected by the first Bragg grating 330 outside.

The third circulator 312 is disposed between the second circulator 313 and the first interleaver 314, which adds the second light signal having a corresponding wavelength to the upstream optical signal input through the first interleaver 314. The upstream optical signal having the second light signal is then output towards the second circulator 313. The third circulator 312 outputs the second light signal, which has a corresponding wavelength and is input through the first port thereof, through the first interleaver 314 and the first Bragg grating 330 towards the second Bragg grating 340, while the second Bragg grating 340 reflects the second light signal towards the first interleaver 314. The first interleaver 314 outputs the second light signal reflected by the second Bragg grating 340 towards the third circulator 312.

The first Bragg grating 330 reflects the first light, which has a corresponding wavelength, of the downstream optical signal output from the first loop 310 towards the first loop 310.

The second loop 320 includes fourth, fifth and sixth circulators 321, 324 and 322 having a ring shape for dropping a second light signal having a corresponding wavelength from a multiplexed upstream optical signal and adding a first light signal having a corresponding wavelength to the downstream optical signal to output the downstream optical signal out of the optical add-drop multiplexer 300, and a second interleaver 323 placed between the fourth and sixth circulators 321 and 322 and connected with the second Bragg grating 340.

The fourth circulator 321 outputs the first light signal, which has a corresponding wavelength and is input through the first port thereof, through the second interleaver 323 and the second Bragg grating 340 towards the first Bragg grating 230, while the first Bragg grating 330 reflects the first light signal having a corresponding wavelength to the second loop 320. The fourth circulator 321 adds the first light signal reflected by the first Bragg grating 330 to the downstream optical signal input from the first loop 310. The downstream optical signal is then output towards the fifth circulator 324.

The fifth circulator 324 outputs the downstream optical signal input from the fourth circulator 321 outside the optical add-drop multiplexer 300, while outputting the multiplexed upstream optical signal input from the outside towards the sixth circulator 322.

The sixth circulator 322 outputs the upstream optical signal through the second interleaver 323 towards the Bragg grating 340. The Bragg grating 340 reflects the second light signal, which has a corresponding wavelength, of the upstream optical signal towards the second interleaver 323. Then, the second interleaver 323 outputs the second light signal reflected by the second Bragg grating 340 towards the sixth circulator 322. The sixth circulator 322 outputs the second light signal through the third port thereof out of the optical add-drop multiplexer 300.

The first Bragg grating 330 is disposed between the first loop 310 and the second Bragg grating 340. The first Bragg grating 330 outputs the downstream optical signal in which a plurality of first light signals besides the first light signal dropped in the first loop are multiplexed towards the Bragg grating 340 while outputs the upstream optical signal in which a plurality of second light signals input from the second Bragg grating 340 and dropped in the second loop 320 are multiplexed towards the first loop 310.

Embodiments of the present invention can be applied to the WDM optical communication network system in which the optical add-drop multiplexers are used as remote nodes. Furthermore, various- embodiments of the present invention can be constructed by using less optical elements than required in the conventional multiplexers.

While the invention has been shown and described with reference to certain embodiments thereof, it will be understood by those skilled in the art that various changes in form and details may be made therein without departing from the spirit and scope of the invention as defined by the appended claims.

What is claimed is:

1. An optical add-drop multiplexer comprising:
a first loop for dropping a first polarized light signal having a corresponding wavelength from a multiplexed downstream optical signal and adding a second polarized light signal having a corresponding wavelength to a multiplexed upstream optical signal;
a second loop for adding another first polarized light signal having a corresponding wavelength to the downstream optical signal input from the first loop and outputting an upstream optical signal from which another second polarized light signal having a corresponding wavelength is dropped towards the first loop; and
a Bragg grating placed between the first and second loops for reflecting the first and second polarized lights signal having the corresponding wavelength respectively towards the first and second loops.

2. The optical add-drop multiplexer as claimed in claim 1, wherein the downstream optical signal is a multiplexed signal including a plurality of first polarized light signals having different wavelengths.

3. The optical add-drop multiplexer as claimed in claim 1, wherein the upstream optical signal is a multiplexed signal including a plurality of second polarized light signals having different wavelengths.

4. The optical add-drop multiplexer as claimed in claim 1, wherein the first loop includes:
a first circulator for outputting a downstream optical signal input through a first port towards a second port of the first circulator and dropping the first polarized light signal reflected by the Bragg grating towards a third port of the first circulator;
a second circulator for outputting a second polarized light signal having a corresponding wavelength input through a first port of the second circulator towards a second port of the second circulator and adding a second polarized light signal reflected by the Bragg grating to the upstream optical signal input through the second port of the second circulator to output the upstream optical signal having the second polarized light signal through a third port of the second circulator; and
a first polarized light signal branching filter for outputting the downstream optical signal output from the first circulator towards the Bragg grating and outputting an upstream optical signal input from the Bragg grating towards the second circulator.

5. The optical add-drop multiplexer as claimed in claim 4, wherein the first loop further includes a second polarized light signal branching filter for inputting the multiplexed downstream optical signal in the first circulator and outputting the upstream optical signal output from the second circulator outside the optical add-drop multiplexer.

6. The optical add-drop multiplexer as claimed in claim 4, wherein the first polarized light signal branching filter includes a polarization signal splitter.

7. The optical add-drop multiplexer as claimed in claim 1, wherein the second loop includes:
a third circulator for outputting an upstream optical signal input through a first port towards a second port of the third circulator and dropping the second polarized light signal reflected by the Bragg grating towards a third port of the third circulator;
a fourth circulator for outputting a first polarized light signal which has a corresponding wavelength and is input through the first port, towards a second port of the fourth circulator and adding a first polarized light signal reflected by the Bragg grating to the downstream optical signal input through the second port of the fourth circulator, to output the downstream optical signal through a third port of the fourth circulator; and
a third polarized light signal branching filter disposed between the third circulator and the fourth circulator and of which one end is connected with the first loop by means of the Bragg grating.

8. The optical add-drop multiplexer as claimed in claim 7, wherein the second loop further includes a fourth polarized light signal branching filter for outputting an upstream optical signal input from the outside towards the third circulator and outputting the downstream optical signal input from the fourth circulator outside the optical add-drop multiplexer.

9. The optical add-drop multiplexer as claimed in claim 1, wherein the downstream optical signal and the upstream optical signal have different wavelength bands.

10. An optical add-drop multiplexer comprising:
a first loop for dropping a first light signal having a corresponding wavelength from a multiplexed downstream optical signal and adding a second light signal having a corresponding wavelength to a multiplexed upstream optical signal;
a second loop for adding a third light signal having a corresponding wavelength to the downstream optical signal input from the first loop and outputting the upstream optical signal in which a forth light signal having a corresponding wavelength is dropped from, towards the first loop; and
first and second Bragg gratings disposed between the first and second loops for reflecting respective light signals having the corresponding wavelength respectively towards the first and second loops.

11. The optical add-drop multiplexer as claimed in claim 1, wherein the first loop includes:
first, second and third circulators forming a ring shaped loop, for dropping the first light signal having a corresponding wavelength from a multiplexed downstream optical signal and adding the second light signal having a corresponding wavelength to the upstream optical signal to output the upstream optical signal outside the optical add-drop multiplexer; and
a first interleaver placed between the first and third circulators and connected with the first Bragg grating.

12. The optical add-drop multiplexer as claimed in claim 1, wherein the second loop includes:
fourth, fifth and sixth circulators forming a ring shaped loop, for dropping the third light signal having a corresponding wavelength from a multiplexed upstream optical signal and adding the fourth light signal having a corresponding wavelength to the downstream optical signal to output the downstream optical signal outside the optical add-drop multiplexer; and
a second interleaver placed between the fourth and sixth circulators and connected with the second Bragg grating.
